(19) United States
(12) Patent Application Publication
(10) Pub. No.: US 2022/0336166 A1
(43) Pub. Date: Oct. 20, 2022

(54) SWITCH DEVICE

(71) Applicants: Tatsuki NAGATA, Aichi (JP); Katsunori KIGOSHI, Aichi (JP); So FUJIOKA, Aichi (JP); Atsushi FUJITA, Aichi (JP); Masahiko HARA, Aichi (JP); Yuki YAMAMOTO, Aichi (JP)

(72) Inventors: Tatsuki NAGATA, Aichi (JP); Katsunori KIGOSHI, Aichi (JP); So FUJIOKA, Aichi (JP); Atsushi FUJITA, Aichi (JP); Masahiko HARA, Aichi (JP); Yuki YAMAMOTO, Aichi (JP)

(73) Assignee: NIDEC MOBILITY CORPORATION, Aichi (JP)

(21) Appl. No.: 17/724,444

(22) Filed: Apr. 19, 2022

(30) Foreign Application Priority Data
Apr. 20, 2021 (JP) 2021-071152

(51) Int. Cl. H01H 13/14; H01H 1/02; H01H 9/54

(52) U.S. Cl. CPC H01H 13/14; H01H 1/02; H01H 9/54

(57) ABSTRACT

A switch device includes: an operation unit including a first switch, a second switch, a first resistor, a second resistor, and a first terminal; and a control unit including a second terminal coupled to the first terminal. A series circuit of the first switch and the first resistor and a series circuit of the second switch and the second resistor are coupled between the first terminal and a ground. The control unit monitors a potential of the first terminal which changes in response to on/off of the first and second switches via the second terminal, and determines the operation state of each switch based on the potential. A contact of the first switch is configured of a contact in which a resistance value between contacts at the time of opening and closing changes more sharply as compared with a contact of the second switch.

### CROSS-REFERENCE TO RELATED APPLICATIONS

This application is based upon and claims the benefit of priority from Japanese Patent Application No. 2021-071152 filed on Apr. 20, 2021, the entire contents of which are incorporated herein by reference.

### FIELD

One or more embodiments of the present invention relate to a switch device such as a power window device that opens and closes a window by operating a switch, and particularly to a switch device including a circuit configuration for discriminating an operation state of a plurality of switches by one input signal.

### BACKGROUND

A power window device equipped in a vehicle is a device that rotates a motor forward or reversely according to an operation state of a switch, and opens and closes a window via an opening/closing mechanism provided between the motor and the window. When the switch is operated to a UP (window closing) side, the motor rotates forward to close the window, and when the switch is operated to a DOWN (window opening) side, the motor rotates reversely to open the window. The forward and reverse rotation of the motor is controlled by switching a direction of a current flowing through the motor.

There are four types of window opening/closing operations: manual closing, automatic closing, manual opening, and automatic opening. In the manual closing operation, the window lifts only while the switch is operated, and when the operation is released, the lifting of the window stops, whereas in the automatic closing operation, the window automatically lifts to a fully closed position and stops even if the operation is released. In addition, in the manual opening operation, the window lowers only while the switch is operated, and when the operation is released, the lowering of the window stops, whereas in the automatic opening operation, the window automatically lowers to a fully open position and stops even if the operation is released. In order to perform these four types of opening/closing operations, four switches of a manual closing switch, an auto-closing switch, a manual opening switch, and an auto-opening switch are provided corresponding to each operation.

In a switch device including such a plurality of switches, in order to reduce the cost of the product, it is effective to reduce the number of pins of a CPU or to use a contact made of an inexpensive material for each switch by making it possible to discriminate the operation state (turning on or off) of a plurality of switches with one input signal.

For example, if one end of each switch is coupled to a ground in common, the other end of each switch is coupled to an output terminal in common via resistors having different resistance values, and a potential of this output terminal is monitored by the CPU, the on/off state of the plurality of switches can be discriminated by one signal input to the CPU from the output terminal. Further, the cost can be reduced by configuring the contact of each switch with an inexpensive carbon contact as described in US-A1-2001/0052729 and JP-A-H11-131907.

### SUMMARY

While the carbon contact is inexpensive, it has a characteristic that a resistance value between contacts at the time of opening and closing changes slowly. Therefore, in a case where an operation state of a plurality of switches is discriminated by one input signal, as described in detail later, there is a problem that a CPU determines the operation state different from an actual operation and the operation of the window does not match the switch operation.

An object of one or more embodiments of the invention is to provide a switch device capable of preventing erroneous determination of a switch operation while suppressing the cost of a contact as much as possible.

A switch device according to one or more embodiments of the present invention includes an operation unit that includes a first switch, a second switch, a first resistor, a second resistor, and a first terminal; and a control unit that performs predetermined control based on an operation state of each of the switches of the operation unit. The control unit includes a second terminal coupled to the first terminal. The first switch and the first resistor are coupled in series, and the series circuit is coupled between the first terminal and a ground. The second switch and the second resistor are coupled in series, and the series circuit is coupled between the first terminal and the ground. The control unit monitors a potential of the first terminal which changes in response to on/off of the first and second switches via the second terminal, and determines the operation state of each of the switches based on the potential. A contact of the first switch is configured of a contact in which a resistance value between contacts at the time of opening and closing changes more sharply as compared with a contact of the second switch.

In one or more embodiments of the present invention, for example, a gold contact of which a contact surface is made of gold can be used for at least one of a movable contact and a fixed contact constituting the contact of the first switch. Further, for at least one of the movable contact and the fixed contact constituting the contact of the second switch, for example, a carbon contact of which a contact surface is made of carbon can be used.

In this way, among the switches coupled between the first terminal and the ground, the contact of the first switch is configured of, for example, a gold contact, and the contact of the second switch is configured of, for example, a carbon contact. Therefore, the use of expensive gold contact can be minimized and the cost increase can be suppressed. In addition, for the gold contact, since the resistance between the contacts at the time of opening and closing changes sharply, the potential of the first terminal also changes sharply, and it is possible to prevent erroneous determination of the switch operation based on the slow change in the potential. Therefore, it is possible to solve a malfunction that an operation that does not match the switch operation is performed.

In one or more embodiments of the present invention, the operation unit may further include a third switch and a third resistor. In this case, a series circuit of the second switch, the second resistor, and the third resistor may be coupled between the first terminal and the ground, and a series circuit of the third switch and the third resistor may be coupled between the first terminal and the ground. The control unit may determine the operation state of each of the switches based on the potential of the first terminal which changes in response to on/off of the first to third switches. The contact of the first switch may be configured of a contact in which the resistance value between the contacts at the time of opening and closing changes more sharply as compared with each contact of the second and third switches.

In one or more embodiments of the present invention, the operation unit may further include a fourth switch coupled in parallel with the third switch. The control unit may determine the operation state of each of the switches based on the potential of the first terminal which changes in response to on/off of the first to fourth switches. The contact of the first switch may be configured of a contact in which the resistance value between the contacts at the time of opening and closing changes more sharply as compared with each contact of the second to fourth switches.

When the first to fourth switches are provided, at least one of the movable contact and the fixed contact constituting the contacts of the first switch may be gold contacts having a contact surface made of gold, and the second to fourth switches may be provided. At least one of the movable contact and the fixed contact constituting the contact may be a carbon contact of which the contact surface is made of carbon.

In one or more embodiments of the present invention, the first switch may be a manual opening switch that is turned on by an operation of manually opening a window to an arbitrary position, the second switch may be a manual closing switch that is turned on by an operation of manually closing the window to an arbitrary position, the third switch may be an auto-opening switch that is turned on by an operation of automatically opening the window to a fully open position in a state where the first switch is turned on, and the fourth switch may be an auto-closing switch that is turned on by an operation of automatically closing the window to a fully closed position in a state where the second switch is turned on.

In one or more embodiments of the present invention, when the first switch is turned on, a current may flow from the first terminal to the series circuit of the first switch and the first resistor, when the second switch is turned on, a current may flow from the first terminal to the series circuit of the second switch, the second resistor, and the third resistor, when the third switch is turned on, a current may flow from the first terminal to the series circuit of the first switch and the first resistor, and the series circuit of the third switch and the third resistor, and when the fourth switch is turned on, a current may flow from the first terminal to a series circuit of the fourth switch and the third resistor.

In one or more embodiments of the present invention, with respect to the potential of the first terminal monitored by the control unit, a first threshold value for determining turning on of the first switch, a second threshold value for determining turning on of the second switch, a third threshold value for determining turning on of the third switch and the first switch, and a fourth threshold value for determining turning on of the fourth switch and the second switch may be set in the control unit, and a relationship among these threshold values may be the second threshold value>the fourth threshold value>the first threshold value>the third threshold value.

According to one or more embodiments of the present invention, it is possible to provide a switch device that does not cause an erroneous determination for a switch operation while suppressing the cost of a contact as much as possible.

### BRIEF DESCRIPTION OF DRAWINGS

FIG. 1 is a circuit diagram illustrating a first embodiment of the present invention;

FIG. 2 is a table illustrating a relationship between a switch operation and conductive switch contacts;

FIGS. 3A and 3B are schematic sectional views illustrating an example of a switch;

FIGS. 4A to 4C are views for explaining an operation of a window opening switch;

FIGS. 5A to 5C are views for explaining an operation of a window closing switch;

FIG. 6 is a diagram for explaining a threshold value for determining an operation state of the switch;

FIG. 7 is a diagram illustrating a potential change in a case where a manual closing operation is performed;

FIG. 8 is a diagram illustrating a potential change in a case where an automatic closing operation is performed;

FIG. 9 is a diagram illustrating a potential change in a case where a manual opening operation is performed;

FIG. 10 is a diagram illustrating a potential change in a case where an automatic opening operation is performed;

FIG. 11 is a diagram for explaining an occurrence of an erroneous determination in a comparative example;

FIG. 12 is a diagram for explaining prevention of the erroneous determination in one or more embodiments of the present invention;

FIG. 13 is a circuit diagram illustrating a second embodiment of the present invention;

FIG. 14 is a circuit diagram illustrating a third embodiment of the present invention;

FIG. 15 is a circuit diagram illustrating a fourth embodiment of the present invention; and

FIG. 16 is a circuit diagram illustrating a fifth embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, embodiments of the present invention will be described with reference to the drawings. In the drawings, the same parts or corresponding parts are designated by the same reference numerals. In the following, as a switch device of one or more embodiments of the present invention, a power window device for a vehicle will be given as an example.

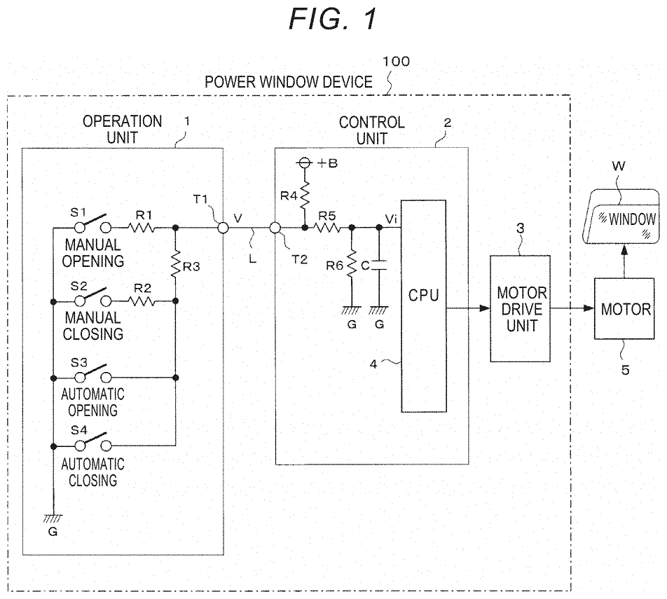

FIG. 1 illustrates a power window device according to a first embodiment. A power window device 100 includes an operation unit 1, a control unit 2, and a motor drive unit 3, and is provided, for example, for each seat such as a driver's seat, an assistant seat, a left back seat, and a right back seat of an automatic four-wheeled vehicle.

The operation unit 1 is configured of a switch unit for operating opening and closing of a window, and has switches S1 to S4, resistors RI to R3, and a terminal Tl. The control unit 2 is configured of a control unit that controls opening and closing of windows based on operations of the switches S1 to S4, and has a CPU 4, resistors R4 to R6, a capacitor C, and a terminal T2. The terminal 1 of the operation unit 1 and the terminal T2 of the control unit 2 are coupled by wiring L. The motor drive unit 3 generates a drive voltage for driving the motor 5 based on a control signal given from the CPU 4. The motor 5 is configured of, for example, a DC motor, rotates in a predetermined direction by a drive voltage output from the motor drive unit 3, and lifts and lowers the window W of the vehicle via a lifting/lowering mechanism (not illustrated).

In the operation unit 1, the switch S1 (first switch) is a manual opening switch for manually opening the window to an arbitrary position, and the switch S2 (second switch) is a manual closing switch for manually closing the window to an arbitrary position. Further, the switch S3 (third switch) is an auto-opening switch for automatically opening the window to a fully open position, and the switch S4 (fourth switch) is an auto-closing switch for automatically closing the window to a fully closed position.

The manual opening switch S1 and the auto-opening switch S3 are configured to be mechanically operated by a common knob (not illustrated). Specifically, when the knob is pushed down, the manual opening switch S1 is first turned on (in a state where the contacts are closed), and the manual opening operation is performed. When the knob is further pushed down from this state, the auto-opening switch S3 is turned on in addition to the manual opening switch S1, and the operation shifts to the automatic opening operation. That is, the auto-opening switch S3 is turned on by the automatic opening operation of the window W continuously in a state where the manual opening switch S1 is turned on by the manual opening operation of the window W.

In the manual opening operation, the window W is opened only while the pushing-down of the knob is held (period during which the manual opening switch S1 is turned on), and when the pushing-down is released, the opening operation of the window W is stopped. On the other hand, in the automatic opening operation, the window W continues to open to the fully open position even if the pushing-down of the knob is released.

Similarly, the manual closing switch S2 and the auto-closing switch S4 are also configured to be mechanically operated by the above-describe common knob. Specifically, when the knob is pulled up, the manual closing switch S2 is first turned on, and the manual closing operation is performed. When the knob is further pulled up from this state, the auto-closing switch S4 is turned on in addition to the manual closing switch S2, and the operation shifts to the automatic closing operation. That is, the auto-closing switch S4 is turned on by the operation of automatically closing the window W continuously in a state where the manual closing switch S2 is turned on by the operation of manually closing the window W.

In the manual closing operation, the window W is closed only while the pulling-up of the knob is held (period during which the manual closing switch S2 is turned on), and when the pulling-up is released, the closing operation of the window W is stopped. On the other hand, in the automatic closing operation, the window W is continuously closed to the fully closed position even if the pulling-up of the knob is released.

One end of the switch S 1 is coupled to the ground G, and the other end thereof is coupled to the terminal T1 (first terminal) via the resistor Rl (first resistor). That is, a series circuit of the switch S1 and the resistor R1 is coupled between the terminal T1 and the ground G. One end of the switch S2 is coupled to the ground G, and the other end thereof is coupled to the terminal Ti via the resistor R2 (second resistor) and the resistor R3 (third resistor). That is, a series circuit of the switch S2, the resistor R2, and the resistor R3 is coupled between the terminal T1 and the ground G.

One end of the switch S3 is coupled to the ground G, and the other end thereof is coupled to the terminal T1 via the resistor R3. That is, the series circuit of the switch S3 and the resistor R3 is coupled between the terminal T1 and the ground G. The switch S4 is coupled in parallel with the switch S3, one end thereof is coupled to the ground G, and the other end thereof is coupled to the terminal T1 via the resistor R3. That is, the series circuit of the switch S4 and the resistor R3 is coupled between the terminal T1 and the ground G.

Next, in the control unit 2, the resistor R4 is a pull-up resistor, one end thereof is coupled to the terminal T2 and the other end thereof is coupled to a power supply +B. The resistors R5 and R6 are voltage dividing resistors that divide the voltage of the power supply +B. One end of the resistor R5 is coupled to the terminal T2, and the other end thereof is coupled to an input side of the CPU 4. One end of the resistor R6 is coupled to the input side of the CPU 4, and the other end thereof is coupled to the ground G. The capacitor C removes a noise component of an analog signal input to the CPU 4, and is coupled in parallel with the resistor R6.

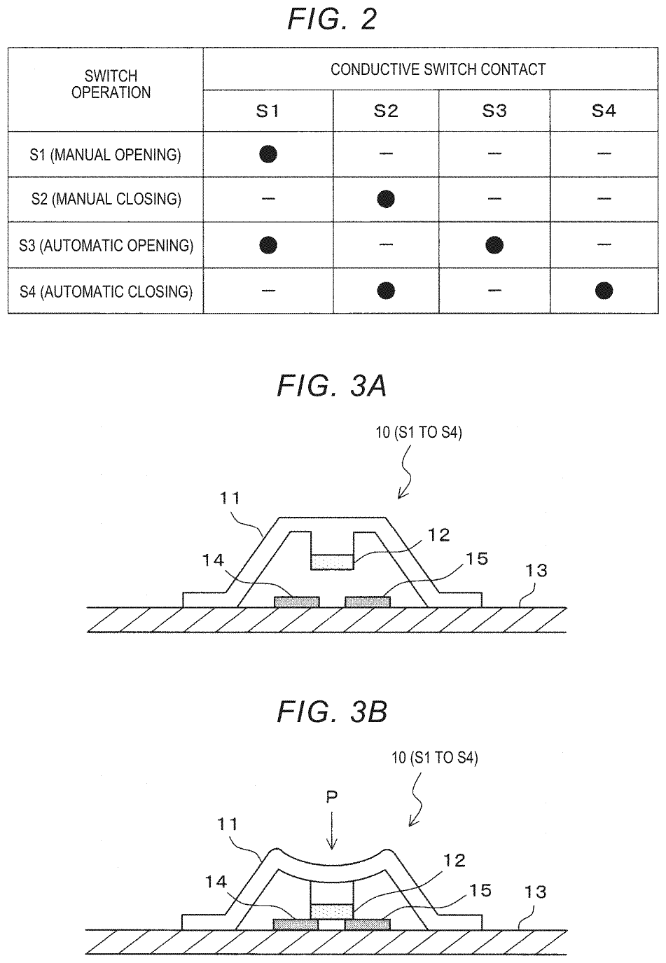

FIG. 2 is a table illustrating a relationship between operations of the switches S1 to S4 and the conductive switch contacts, and represents black circles that represent a turning on state of the switch. When the knob is pushed down and the switch S1 is operated (manual opening operation), the contacts of the switch S1 are conductive and the switch S1 is turned on.

Further, when the knob is pulled up and the switch S2 is operated (manual closing operation), the contacts of the switch S2 are conductive and the switch S2 is turned on.

On the other hand, when the knob is further pushed down from the state of the manual opening operation (automatic opening operation), the contacts of the switch S3 in addition to the contacts of the switch S1 are conductive, and the switches Si and S3 are turned on. Further, when the knob is further pulled up from the state of the manual closing operation (automatic closing operation), the contacts of the switch S4 in addition to the contacts of the switch S2 are conductive, and the switches S2 and S4 are turned on.

FIGS. 3A and 3B illustrate an example of the switches S1 to S4. In the present embodiment, the switches S1 to S4 are configured of a rubber switch 10, and include a rubber dome 11 interlocking with the operation of the knob (not illustrated), and a movable contact 12 and fixed contacts 14 and 15 constituting the contacts of the switches S 1 to S4. The rubber dome 11 is made of an elastic rubber material and is formed in a hollow truncated cone shape. The movable contact 12 is provided on a protruding portion of an inner upper portion of the rubber dome 11. The fixed contacts 14 and 15 are provided on a surface of the circuit board 13 on which the rubber switch 10 is mounted, and face the movable contact 12.

FIG. 3A illustrates a state where the rubber dome 11 is not pressed because the knob is not operated. In this state, the movable contact 12 is separated from the fixed contacts 14 and 15, and the rubber switch 10 is turned off. FIG. 3B illustrates a state where the rubber dome 11 is pressed in a P direction by operating the knob. In this state, the rubber dome 11 is elastically deformed as illustrated in the drawing, the movable contact 12 comes into contact with the fixed contacts 14 and 15, and the rubber switch 10 is turned on.

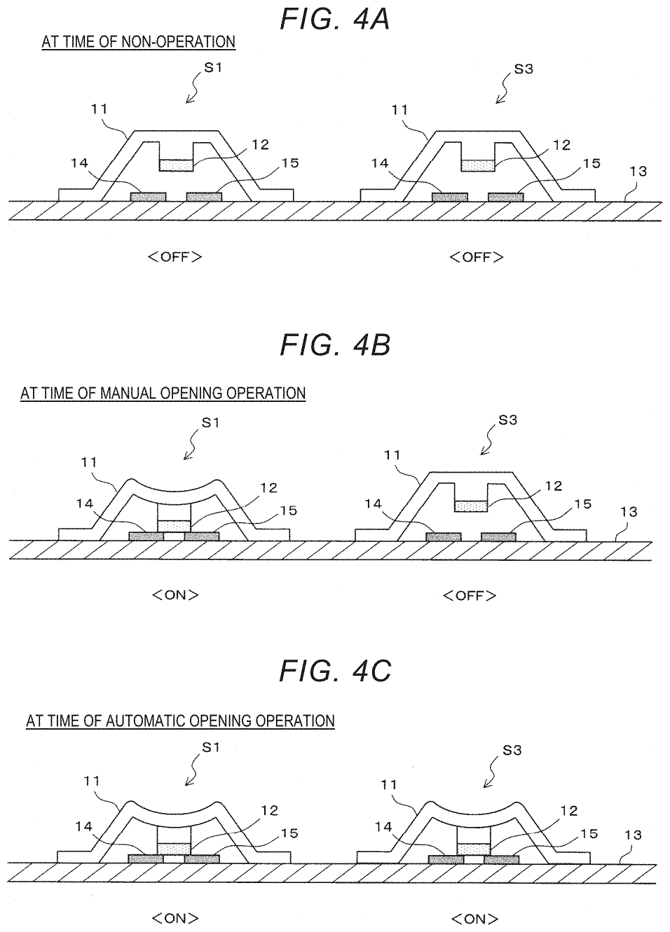

FIGS. 4A to 4C are views illustrating the operations of the window opening switches S1 and S3. FIG. 4A illustrates a state where the knob is not operated, the movable contacts 12 of the switches S1 and S3 are separated from the fixed contacts 14 and 15, and both switches are turned off. FIG. 4B illustrates a state where the knob is pushed down and the manual opening operation is performed, the movable contact 12 of the switch S1 (manual opening switch) comes into contact with the fixed contacts 14 and 15, and the switch S1 is turned on. The switch S3 remains in being turned off. FIG. 4C illustrates a state where the knob is further pushed down to perform the automatic opening operation, the movable contact 12 of the switch S3 (auto-opening switch) comes into contact with the fixed contacts 14 and 15, and both the switches S1 and S3 are turned on.

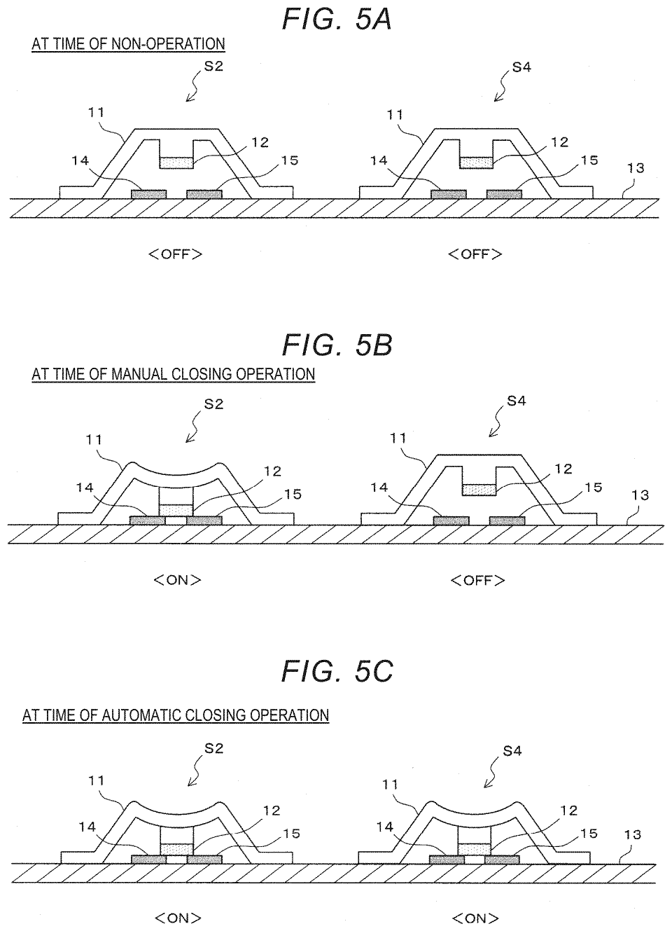

FIGS. 5A to 5C are views illustrating the operation of the window closing switches S2 and S4. FIG. 5A illustrates a state where there is no knob operation, the movable contacts 12 of the switches S2 and S4 are separated from the fixed contacts 14 and 15, and both switches are turned off. FIG. 5B illustrates a state where the knob is pulled up and the manual closing operation is performed, the movable contact 12 of the switch S2 (manual closing switch) comes into contact with the fixed contacts 14 and 15, and the switch S2 is turned on. The switch S4 remains being turned off. FIG. 5C illustrates a state where the knob is further pulled up and the automatic closing operation is performed, the movable contact 12 of the switch S4 (auto-closing switch) comes into contact with the fixed contacts 14 and 15, and both the switches S2 and S4 are turned on.

Next, a material of the contacts of the switches S1 to S4, which is a feature of one or more embodiments of the present invention, will be described. In the following, in a case where the switches S1 to S4 are simply referred to as the “contact ”, it refers to the movable contact 12.

In FIG. 1, a gold contact of which a contact surface is made of gold is used as the contact of the switch S1. As the gold contact, for example, one in which a surface of a base material of a metal or a resin is plated with gold (gold-plated contact) or one in which a thin plate of gold is attached to the surface of the base material (gold clad contact) can be used. Although the gold contact is expensive, it has a low electrical resistance and excellent conductivity, and does not easily form an oxide film on the surface, also has excellent contact stability, and a characteristic that a resistance value between the contacts at the time of opening and closing (at the time of contact and separation) changes sharply.

On the other hand, in FIG. 1, carbon contacts of which contact surfaces are made of carbon are used as the contacts of the switches S2 to S4. As the carbon contact, for example, one in which carbon is baked and printed on the surface of the base material, or one to which a carbon chip is attached can be used. Alternatively, one may be used which is obtained by coating a carbon paste on the surface of the base material and thermosetting. Although the carbon contact is inexpensive, it is inferior to the gold contact in terms of conductivity and contact stability, and has a characteristic that the resistance value between the contacts at the time of opening and closing changes more slowly as compared with the gold contact.

The fixed contacts 14 and 15 illustrated in FIGS. 3A and 3B are configured of carbon contacts in each of the switches S1 to S4. Alternatively, the fixed contacts 14 and 15 may be configured of a copper foil having a pattern printed on the surface of the circuit board 13.

By the way, the resistor R2 coupled in series with the switch S2 using the carbon contacts has a larger resistance value than that of the resistor RI coupled in series with the switch S1 using the gold contacts (R2>R1). Further, in the present embodiment, the resistor R3 coupled in series with the switches S3 and S4 using the carbon contacts also has a larger resistance value than that of the resistor R1 (R3>R1). Incidentally, the resistance value of the resistor R3 is larger than that of the resistor R2 (R3>R2). The reason why the contact materials of the switches S1 to S4 and the resistance values of the resistors RI to R3 are selected as described above will be clarified later.

Next, a method in which the CPU 4 of the control unit 2 determines the operation states of the switches S1 to S4 will be described in detail.

In FIG. 1, when at least one of the switches S1 to S4 is turned on, a current flows from the power supply +B to the circuit of the operation unit 1 through the resistor R4, the terminal T2, the wiring L, and the terminal T1, and the potential V of the terminal T1 lifts. This potential V changes in response to the on/off state of the switches S1 to S4, and the resistance values of the resistors R1 to R3 are different. Therefore, in the terminal T1, four different potentials appear corresponding to four operations of manual opening (S1: turned on), manual closing (S2: turned on), automatic opening (S1+S3: turned on), and automatic closing (S2+S4: turned on) (details will be described later).

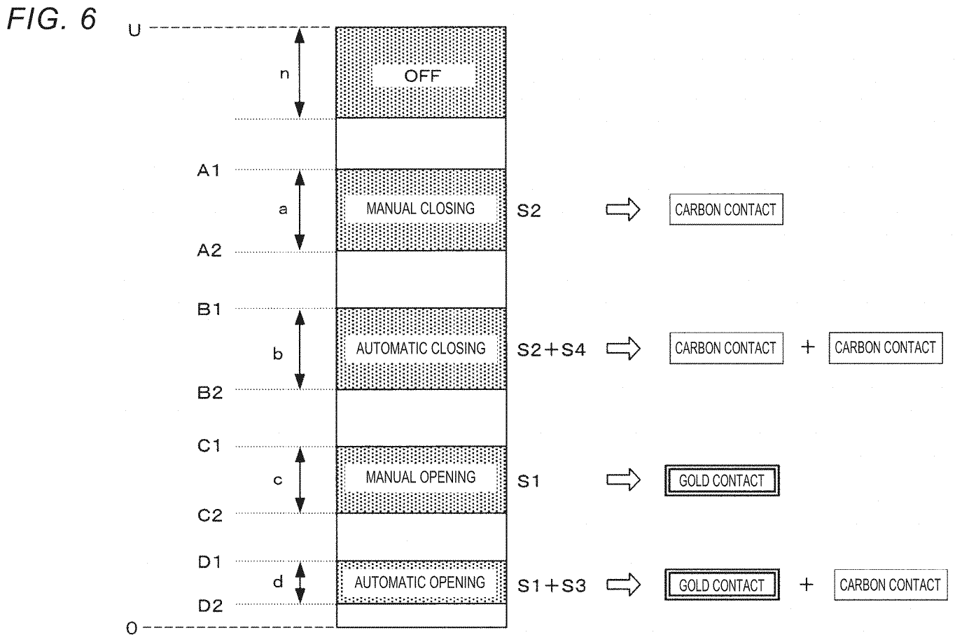

The CPU 4 of the control unit 2 monitors the potential V of the terminal T1 via the wiring L and the terminal T2, and determines the operation states of the switches S1 to S4 based on the potential V. Then, the CPU 4 outputs four types of control signals according to those operation states to the motor drive unit 3. Since the potential V is not directly input to the CPU 4, the CPU 4 monitors the potential V of the terminal T1 based on a voltage V1 input via the resistors R5 and R6, and the capacitor C. With respect to this potential V, as illustrated in FIG. 6, five determination regions n and a to d are set in the CPU 4 between a voltage U and zero volt. The voltage U is a voltage obtained by dividing the voltage of the power supply +B in FIG. 1 by the resistors R4 to R6.

In FIG. 6, n is a region for determining that all of the switches S1 to S4 are turned off, a is a region for determining that the switch S2 is turned on by the manual closing operation, b is a region for determining that the switch S4 (and S2) is turned on by the automatic closing operation, c is the region for determining that the switch S1 is turned on by the manual opening operation, and d is a region for determining that the switch S3 (and S1) is turned on by the automatic opening operation.

The determination region a is a region between an upper limit threshold value A1 and a lower limit threshold value A2 for determining the turning-on of the switch S2, and the determination region b is a region between an upper limit threshold value B1 and a lower limit threshold value B2 for determining the turning-on of the switch S4 (and S2). Further, the determination region c is a region between an upper limit threshold value C1 and a lower limit threshold value C2 for determining the turning-on of the switch S1, and the determination region d is a region between an upper limit threshold value D1 and a lower limit threshold value D2 for determining the turning-on of the switch S3 (and S1).

Each of the above-described threshold values is stored in advance in an internal memory (not illustrated) built in the CPU 4 or an external memory (not illustrated) provided separately from the CPU 4. Of these, the upper limit threshold value A1 corresponds to the “second threshold value” in one or more embodiments of the present invention, the upper limit threshold value B1 corresponds to the “fourth threshold value” in one or more embodiments of the present invention, the upper limit threshold value C1 corresponds to the “first threshold value” in one or more embodiments of the present invention, and the upper limit threshold value D1 corresponds to the “third threshold value” in one or more embodiments of the present invention. As can be seen from FIG. 6, a relationship between these threshold values is Al >B1>C1>D1.

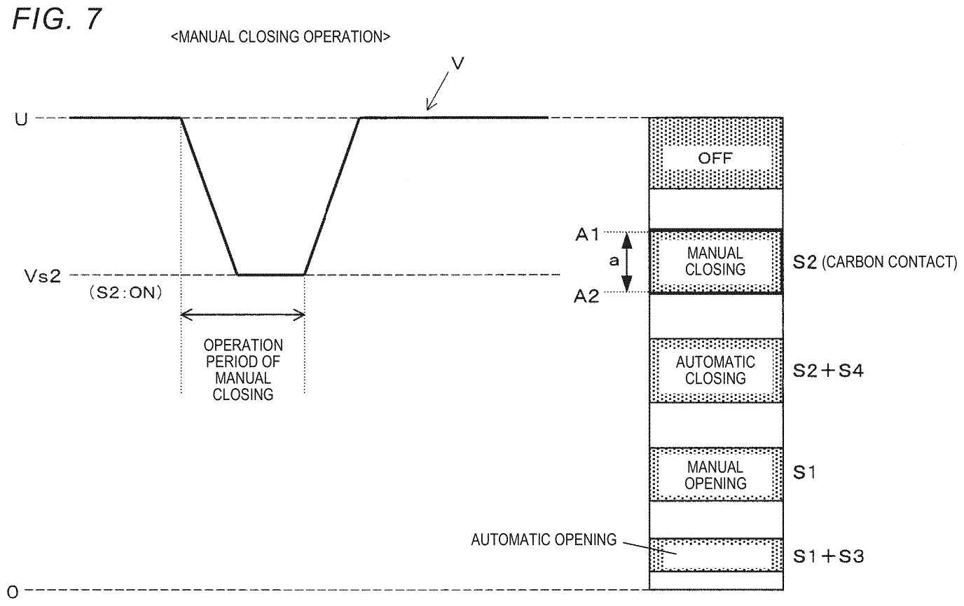

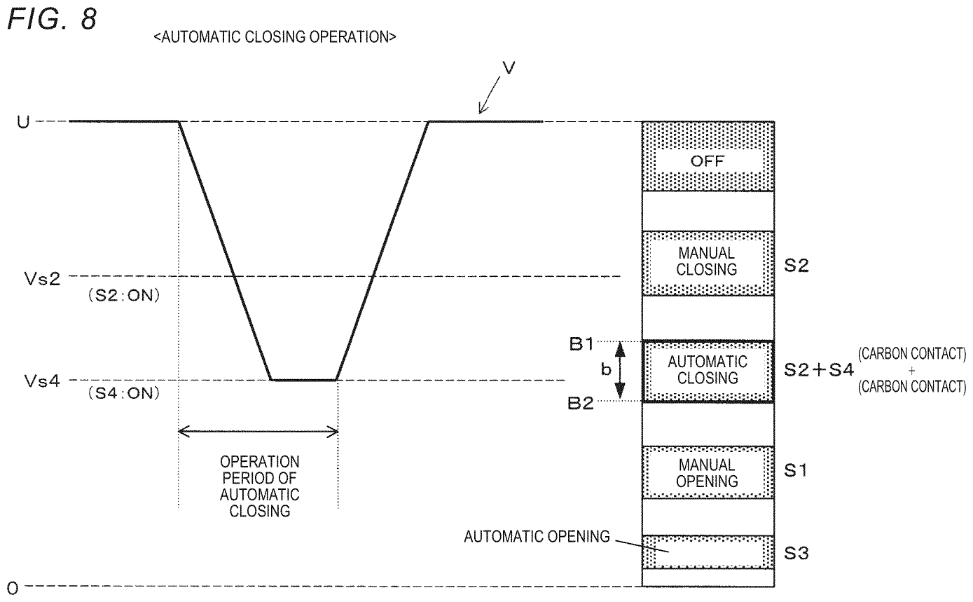

FIG. 7 illustrates a change in the potential V of the terminal T1 in a case where the “manual closing operation” is performed. A horizontal axis is time and a vertical axis is a potential (the same applies to FIGS. 8 to 12). The change in the potential V in FIG. 7 is actually a little more complicated, but is illustrated here in a simplified and schematic manner (the same applies to FIG. 8 and subsequent figures). In the case of FIG. 7, when the switch S2 is turned on, a current flows in a path of power supply +B→resistor R4→terminal T2→wiring L→terminal T1→resistor R3 resistor R2→switch S2→ground G in FIG. 1, and the potential V of the terminal T1 drops from U to Vs2. Then, if this Vs2 is in the determination region a, that is, if A1≥Vs2≥A2, the CPU 4 determines that the manual closing operation is performed and the switch S2 is turned on.

In the case of FIG. 7, since the switch S2 that is turned on is the carbon contact, the change in the resistance between the contacts at the time of opening and closing in the switch S2 becomes slow as described above. As a result, the change in the potential V becomes slow as illustrated in the drawing, but in the process until the potential V reaches the determination region a of the manual closing operation, since the potential V does not reach the determination regions b to d of other operations (FIG. 6), there is no problem in determining the manual closing.

FIG. 8 illustrates a change in the potential V of the terminal T1 in a case where the “automatic closing operation” is performed. In this case, since the switches S2 and S4 are both turned on, a current flows in a path of power supply +B→resistor R4 terminal T2→wiring L'terminal T1→resistor R3→switch S4→ground G in FIG. 1 (switch S2 and resistor R2 are short-circuited by the switch S4, so no current flows), and the potential V of the terminal T1 drops from U to Vs4. Since no current flows through the resistor R2, Vs4 has a value lower than Vs2 in FIG. 7 (Vs4<Vs2). Then, if this Vs4 is in the determination region b, that is, if B1≥Vs4≥B2, the CPU 4 determines that the automatic closing operation is performed and the switches S2 and S4 are turned on.

Also in FIG. 8, since the switches S2 and S4 that are turned on are both the carbon contacts, the change in the potential V is slow. Then, in the case of FIG. 8, the potential V passes through the determination region a of FIG. 7 in the process in which the potential V is changed between U and Vs4. Therefore, in the determination region a, the CPU 4 may erroneously determine that it is the “manual closing operation”, but even in that case, since the window closing operation is still performed, there is no problem in the automatic closing operation.

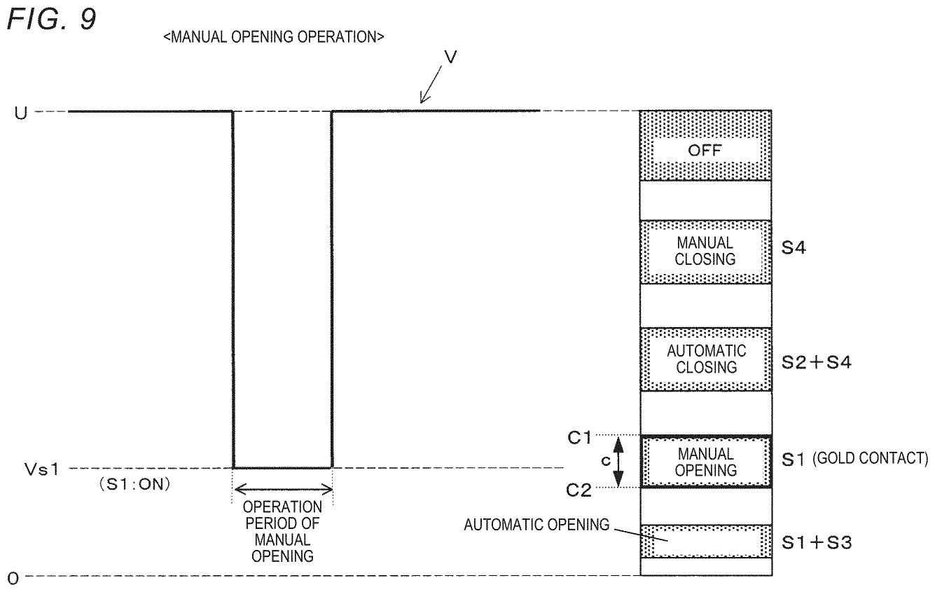

FIG. 9 illustrates a change in the potential V of the terminal T1 in a case where the “manual opening operation” is performed. In this case, when the switch S1 is turned on, a current flows in a path of power supply +B→resistor R4→terminal T2→wiring L→terminal T1→resistor R1→switch S1→ground G in FIG. 1, and the potential V of the terminal T1 drops to from U to Vs1. Here, since the resistor RI has a smaller resistance value than those of the resistors R2 and R3, and the contact of the switch S1 is also the gold contact and has a small resistance value, Vs1 is a value lower than Vs2 (FIG. 7) and Vs4 (FIG. 8) (Vs1 <Vs4<Vs2). Then, if this Vs1 is within the determination region c, that is, if C1>Vs1>C2, the CPU 4 determines that the manual opening operation is performed and the switch S 1 is turned on.

In the case of FIG. 9, since the contact of the switch S1 turned on is the gold contact, the change in the resistance between the contacts at the time of opening and closing in the switch S1 becomes sharp as described above. Therefore, the change in the potential V also becomes sharp as illustrated in the drawing, and the potential V drops from U to Vs1 at once. Therefore, there is no possibility that the CPU 4 erroneously determines the “manual closing operation” or the “automatic closing operation” in the process in which the potential V is changed. This will be discussed in more detail later.

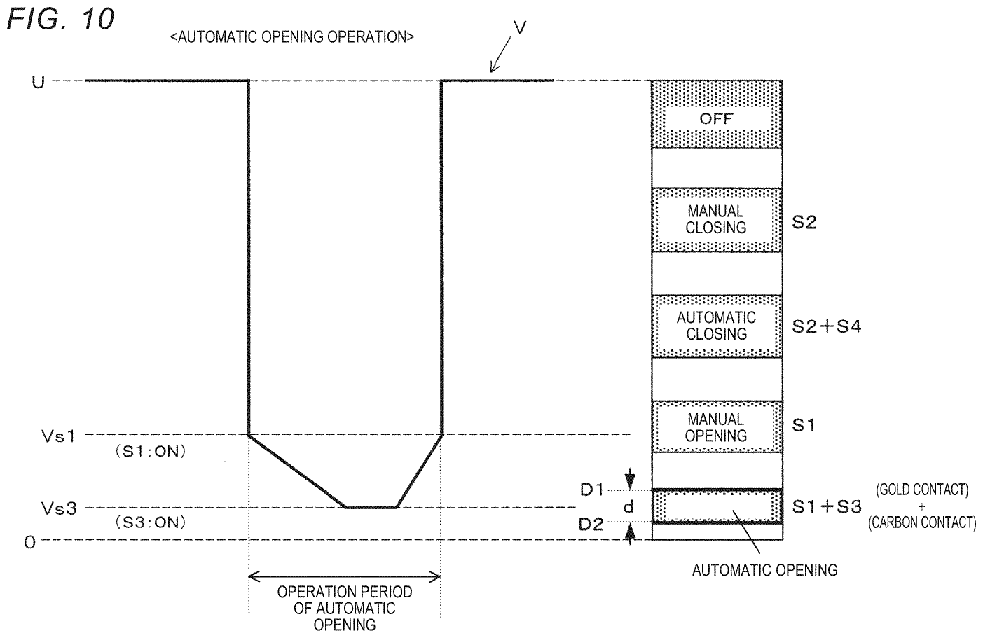

FIG. 10 illustrates a change in the potential V of the terminal T1 in a case where the “automatic opening operation” is performed. In this case, since the switches S1 and S3 are both turned on, a current flows in a path of the power supply +B→resistor R4→terminal T2→wiring L→terminal T1→resistor R1→switch S1 ground G, and a path of terminal T1→resistor R3→switch S3→ground G in FIG. 1, and the potential V of the terminal T1 drops from U to Vs3. Since the current flows through both the resistor R1 and the resistor R3, Vs3 has a value lower than Vs1 (FIG. 9) (Vs3<Vs1). Then, if this Vs3 is within the determination region d, that is, if D1≥Vs3≥D2, the CPU 4 determines that the automatic opening operation is performed and the switches S1 and S3 are turned on.

Here, in the case of the automatic opening operation, the switch S3 is turned on after the switch S1 is turned on, but since the contact of the switch S1 is the gold contact, the potential V drops at once to Vs1 as in FIG. 9. Therefore, in the process of this change, there is no possibility that the CPU 4 erroneously determines that it is the “manual closing operation” or the “automatic closing operation”. This will also be described in detail later. On the other hand, since the contact of the switch S3 is the carbon contact, the potential V slowly changes from Vs1 to Vs3. However, even if the CPU 4 erroneously determines that the operation is the “manual opening operation” in the process of this change, since the window opening operation is still performed, there is no problem in the automatic opening operation.

As described above, in the above-described embodiment, the contacts of the switch S1 are configured of the gold contacts, the contacts of the switches S2 to S4 are configured of the carbon contacts, and the resistance values of the resistors R1 to R3 are selected as R1<R2<R3. Therefore, the operation state of each switch can be determined by using the threshold value set as illustrated in FIG. 6, and an accurate operation matching the operation can be performed.

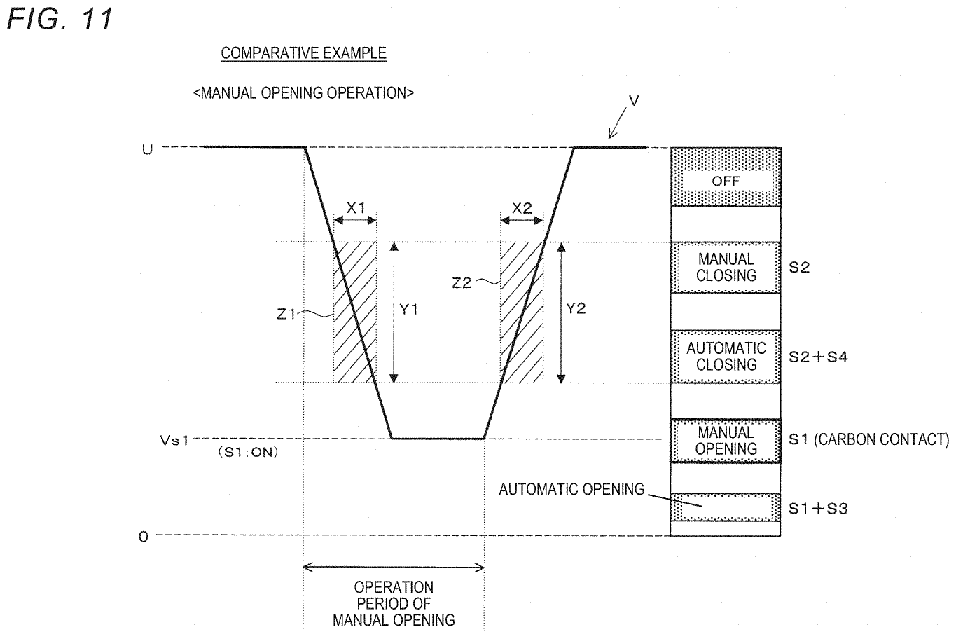

In particular, one or more embodiments of the present invention operate effectively in a case where the “manual opening” or “automatic opening” operation in which the threshold value for the potential V is set small is performed. FIG. 11 is a comparative example in a case where all the contacts of the switches S1 to S4 are the carbon contacts, and illustrates a change in the potential V when the “manual opening” operation is performed.

In this comparative example, since the contact of the switch S1 is the carbon contact, the potential V slowly decreases from U to Vs1 when the switch S1 is turned on. In this process, a change curve of the potential V passes through an erroneous determination region Z1. X1 represents a time width of the erroneous determination region Z1 and Y1 represents a potential width of the erroneous determination region Z1. As can be seen from the drawing, since the change in the potential V is slow, the time X1 in which the change curve passes through the potential width Y1 of the erroneous determination region Z1 also becomes long. Therefore, during this time X1, the CPU 4 erroneously determines that the switch operation is “manual closing” or “automatic closing”. As a result, there is a malfunction that the window closes even though the “manual opening” operation is performed to open the window.

Further, even in a case where the manual opening operation is released and the switch S1 is turned off, since the potential V slowly lifts from Vs1 to U, the change curve of the potential V passes through the erroneous determination region Z2 in this process. X2 represents a time width of the erroneous determination region Z2, and Y2 represents a potential width of the erroneous determination region Z2 (Y2=Y1). As can be seen from the drawing, since the change in the potential V is slow, the time X2 in which the change curve of the potential V passes through the potential width Y2 of the erroneous determination region Z2 also becomes long. Therefore, during this time X2, the CPU 4 erroneously determines that the switch operation is “manual closing” or “automatic closing”. As a result, there is a malfunction that the window closes even though the “manual opening” operation is released in order to stop the window.

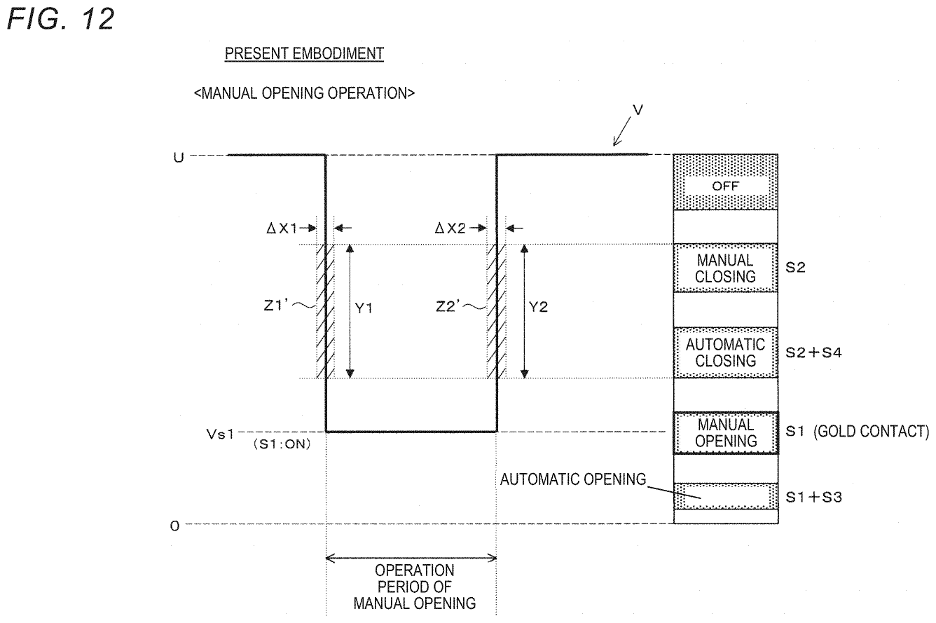

On the other hand, in the case of one or more embodiments of the present invention, since the contact of the switch S1 is the gold contact, the change in the potential V becomes sharp as illustrated in FIG. 12. In FIG. 12, Z1′ and Z2′ are regions corresponding to Z1 and Z2 in FIG. 11. AX1 and AX2 represent the time widths of the regions Z1′ and Z2′, and Y1 and Y2 represent the potential widths of the regions Z1′ and Z2′(Y2=Y1). In FIG. 12, the time widths ΔX1 and ΔX2 are exaggerated for convenience, but since the change in the potential V is sharp, the actual time widths ΔX1 and ΔX2 are extremely short, and the change curve of the potential V passes through the potential widths Y1 and Y2 of the region Z1′ and Z2′ for a moment. Further, the time widths AX1 and AX2 are shorter than the time required for the determination processing of the CPU 4. Therefore, in a case where the operation of “manual opening” is performed, there is no possibility that the CPU 4 erroneously determines “manual closing” or “automatic closing” in the region Z1′, and the manual opening operation is performed according to the operation. Further, even in a case where the operation of “manual opening” is released, there is no possibility that the CPU 4 erroneously determines “manual closing” or “automatic closing” in the region Z2′, and the manual opening operation is stopped according to the operation.

In FIG. 12, an example of “manual opening” is given, but even in the case of “automatic opening”, since the potential V changes sharply between U and Vs1 (see FIG. 10), there is no possibility that the CPU 4 erroneously determines “manual closing” or “automatic closing” in the process of this change, the automatic opening operation is performed according to the operation, and the automatic opening operation is stopped according to the operation.

As described above, in the first embodiment, among the switches S1 to S4 coupled between the terminal T1 and the ground G, the contact of the switch S1 is configured of the gold contact, and the contacts of the switches S2 to S4 are configured of the carbon contacts.

Therefore, the use of expensive gold contact can be minimized and the cost increase can be suppressed. In addition, by utilizing the sharp change in resistance between contacts at the time of opening and closing, which is the characteristic of the gold contact, erroneous determination of the switch operation by the CPU 4 is prevented. Therefore, it is possible to solve a malfunction that the window opening/closing operations that do not match the switch operation.

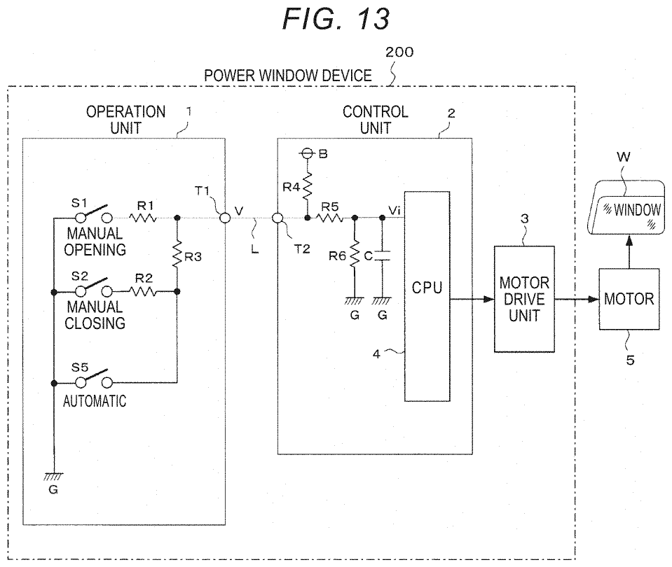

FIG. 13 illustrates a power window device 200 according to a second embodiment of the present invention. In FIG. 13, the auto-opening switch S3 and the auto-closing switch S4 of FIG. 1 are replaced with an automatic switch S5. The automatic switch S5 is the same rubber switch 10 as that in FIGS. 3A and 3B, and the movable contact 12 is configured of a carbon contact. Since other configurations are the same as those in FIG. 1, the description of the parts common to those in FIG. 1 will be omitted.

The automatic switch S5 corresponds to the “third switch” in one or more embodiments of the present invention, and includes functions of both the auto-opening switch and the auto-closing switch. Specifically, when the manual opening switch S1 is turned on by the manual opening operation and then the automatic opening operation is continuously performed, the automatic switch S5 is turned on and the automatic opening operation is performed. Further, if the automatic closing operation is continuously performed after the manual closing switch S2 is turned on by the manual closing operation, the automatic switch S5 is turned on and the automatic closing operation is performed.

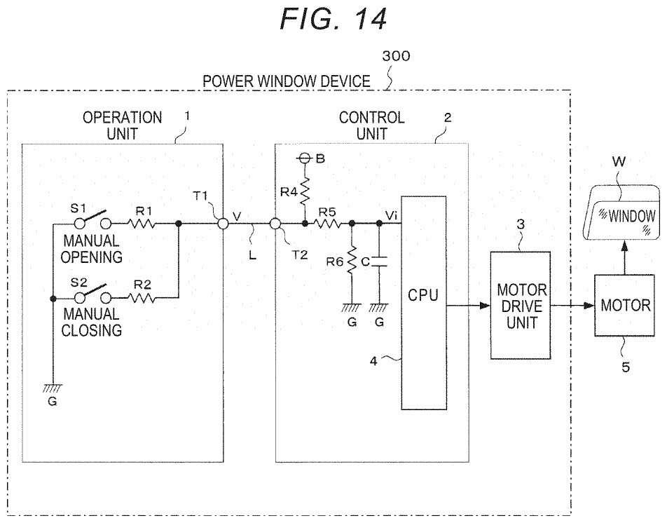

FIG. 14 illustrates a power window device 300 according to a third embodiment of the present invention. In FIG. 14, the auto-opening switch S3, the auto-closing switch S4, and the resistor R3 of FIG. 1 are removed. Since other configurations are the same as those in FIG. 1, the description of the parts common to those in FIG. 1 will be omitted.

With such a second embodiment and a third embodiment, the same effects as those of the first embodiment can be obtained.

In one or more embodiments of the present invention, various embodiments as described below can be adopted in addition to the embodiments described above.

In the above-described embodiments, the rubber switch 10 as illustrated in FIGS. 3A and 3B is taken as an example, but the switch used in the switch device of one or more embodiments of the present invention is not limited to the rubber switch, and may be a membrane switch, a slide switch, or the like.

In the above-described embodiments, the contact of the switch S1 is the gold contact, but the material of the contact of the switch S1 is not limited to gold, and may be platinum, silver, copper, or an alloy thereof. Similarly, in the above-described embodiments, the contacts of the switches S2 to S5 are the carbon contacts, but the material of the contacts of the switches S2 to S5 is not limited to carbon, and may be palladium, nickel, or an alloy thereof.

In the above-described embodiments, the movable contact 12 of the switch S1 is the gold contact and the fixed contacts 14 and 15 are the carbon contacts, but conversely, the fixed contacts 14 and 15 of the switch S1 may be the gold contacts and the movable contact 12 may be the carbon contact. Further, both the movable contact 12 and the fixed contacts 14 and 15 of the switch S1 may be the gold contacts.

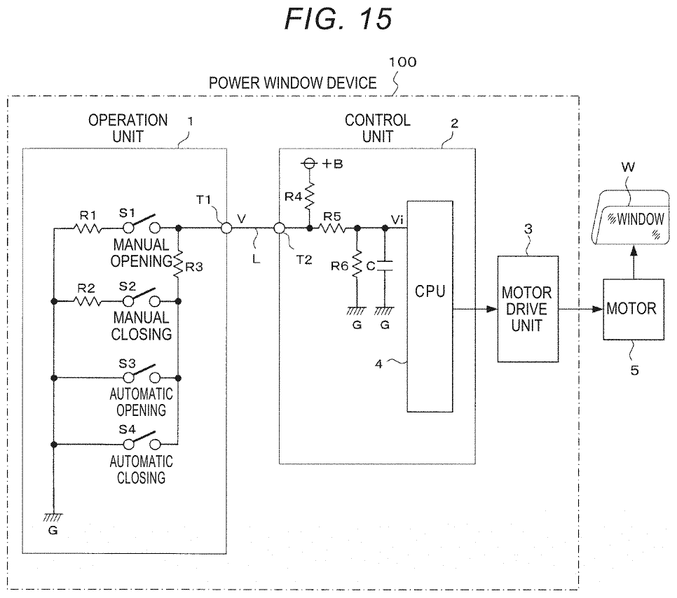

In the embodiment of FIG. 1, among the switch S1 and the resistor R1 coupled in series, the switch S1 is provided on the ground G side and the resistor R1 is provided on the terminal T1 side, and among the switch S2 and the resistor R2 coupled in series, the switch S2 is provided on the ground G side and the resistor R2 is provided on the terminal T1 side, but one or more embodiments of the present invention are not limited thereto. As illustrated in the fourth embodiment of FIG. 15, the resistors R1 and R2 may be provided on the ground G side, and the switches S1 and S2 may be provided on the terminal T1 side. The same applies to FIGS. 13 and 14.

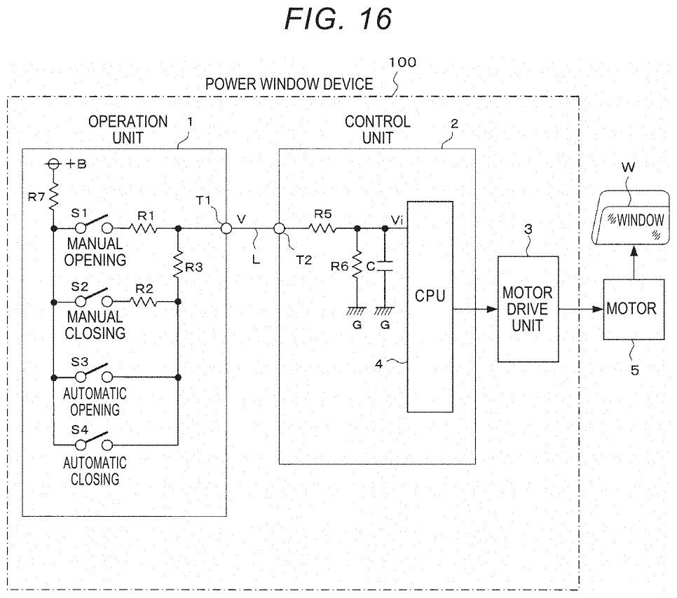

In the embodiment of FIG. 1, an example in which the power supply +B and the pull-up resistor R4 are provided in the control unit 2 is given, but as illustrated in the fifth embodiment of FIG. 16, the power supply +B and the pull-up resistor R7 may be provided in the operation unit 1. Further, the pull-up resistor R7 in FIG. 16 can be omitted.

In the above-described embodiments, an example in which the motor drive unit 3 is provided separately from the control unit 2 is given, but the motor drive unit 3 may be incorporated in the control unit 2.

In the above-described embodiments, an example in which the motor 5 is provided outside the power window devices 100, 200, and 300 is given, but the motor 5 may be included in the power window device.

In the above-described embodiments, an example in which the present invention is applied to the power window device for the vehicle is given, but the present invention can also be applied to a power window device used in a field other than the vehicle, and further, can also be applied to a switch device other than power window device.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A switch device comprising:
an operation unit comprising a first switch, a second switch, a first resistor, a second resistor, and a first terminal; and
a control unit comprising a second terminal coupled to the first terminal, the control unit being configured to perform predetermined control based on an operation state of each switch of the operation unit,
wherein a series circuit of the first switch and the first resistor is coupled between the first terminal and a ground,
wherein a series circuit of the second switch and the second resistor is coupled between the first terminal and the ground,
wherein the control unit monitors a potential of the first terminal which changes in response to on/off of the first and second switches via the second terminal, and determines the operation state of each switch based on the potential, and
wherein a contact of the first switch is configured of a contact in which a resistance value between contacts at the time of opening and closing changes more sharply as compared with a contact of the second switch.

2. The switch device according to claim 1,
wherein the operation unit further comprises a third switch and a third resistor,
wherein a series circuit of the second switch, the second resistor, and the third resistor is coupled between the first terminal and the ground,
wherein a series circuit of the third switch and the third resistor is coupled between the first terminal and the ground,
wherein the control unit determines an operation state of each switch based on a potential of the first terminal which changes in response to on/off of the first to third switches, and
wherein the contact of the first switch is configured of a contact in which the resistance value between the contacts at the time of opening and closing changes sharply as compared with each contact of the second and third switches.

3. The switch device according to claim 2,
wherein the operation unit further comprises a fourth switch coupled in parallel with the third switch,
wherein the control unit determines an operation state of each switch based on a potential of the first terminal which changes in response to on/off of the first to fourth switches, and
wherein the contact of the first switch is configured of a contact in which the resistance value between the contacts at the time of opening and closing changes more sharply as compared with each contact of the second to fourth switches.

4. The switch device according to claim 3,
wherein at least one of a movable contact and a fixed contact constituting the contact of the first switch is a gold contact of which a contact surface is made of gold, and
wherein at least one of a movable contact and a fixed contact constituting contacts of the second to fourth switches is a carbon contact of which a contact surface is made of carbon.

5. The switch device according to claim 3,
wherein the first switch is a manual opening switch that is turned on by an operation of manually opening a window to an arbitrary position,
wherein the second switch is a manual closing switch that is turned on by an operation of manually closing the window to an arbitrary position,
wherein the third switch is an auto-opening switch that is turned on by an operation of automatically opening the window to a fully open position in a state where the first switch is turned on, and
wherein the fourth switch is an auto-closing switch that is turned on by an operation of automatically closing the window to a fully closed position in a state where the second switch is turned on.

6. The switch device according to claim 5,
wherein when the first switch is turned on, a current flows from the first terminal to the series circuit of the first switch and the first resistor,
wherein when the second switch is turned on, a current flows from the first terminal to the series circuit of the second switch, the second resistor, and the third resistor,
wherein when the third switch is turned on, a current flows from the first terminal to the series circuit of the first switch and the first resistor, and the series circuit of the third switch and the third resistor, and
wherein when the fourth switch is turned on, a current flows from the first terminal to a series circuit of the fourth switch and the third resistor.

7. The switch device according to claim 6,
wherein a first threshold value, a second threshold value, a third threshold value and a fourth threshold value are set in the control unit with respect to the potential of the first terminal to be monitored by the control unit, where:
the first threshold value for determining turning on of the first switch,
the second threshold value for determining turning on of the second switch,
the third threshold value for determining turning on of the third switch and the first switch, and
the fourth threshold value for determining turning on of the fourth switch and the second switch, and
wherein a relationship among the first to fourth threshold values is the second threshold value>the fourth threshold value>the first threshold value>the third threshold value.

8. A switch device comprising:
an operation unit comprising a first switch, a second switch, a first resistor, a second resistor, and a first terminal; and
a control unit comprising a second terminal coupled to the first terminal, the control unit being configured to perform predetermined control based on an operation state of each switch of the operation unit,
wherein a series circuit of the first switch and the first resistor is coupled between the first terminal and a ground,
wherein a series circuit of the second switch and the second resistor is coupled between the first terminal and the ground,
wherein the control unit monitors a potential of the first terminal which changes in response to on/off of the first and second switches via the second terminal, and determines the operation state of each switch based on the potential,
wherein at least one of a movable contact and a fixed contact constituting a contact of the first switch is a gold contact of which a contact surface is made of gold, and
wherein at least one of a movable contact and a fixed contact constituting a contact of the second switch is a carbon contact of which a contact surface is made of carbon.
